(19) United States
(12) Patent Application Publication
(10) Pub. No.: US 2022/0399591 A1
(43) Pub. Date: Dec. 15, 2022

(54) SYSTEM FOR BATTERY MANAGEMENT IN ELECTRIC AIRCRAFT

(71) Applicant: BETA AIR, LLC, SOUTH BURLINGTON, VT (US)

(72) Inventors: Stuart Denson Schreiber, Essex, VT (US); Nathan William Joseph Wiegman, Essex Junction, VT (US); Tom Michael Hughes, Bristol, VT (US)

(73) Assignee: BETA AIR, LLC, SOUTH BURLINGTON, VT (US)

(21) Appl. No.: 17/348,384

(22) Filed: Jun. 15, 2021

(51) Int. Cl. H01M 10/653; H01M 10/613; H01M 50/105; H01M 50/533; B60L 50/64

(52) U.S. Cl. CPC H01M 10/653; H01M 10/613; H01M 50/105; H01M 50/533; B60L 50/64; H01M 2220/20

(57) ABSTRACT

A system and method for a thermal management system for a plurality of battery cells.

### FIELD OF THE INVENTION

The present invention generally relates to the field of battery management for electric vehicles. In particular, the present invention is directed to a system and method for battery management for an electric aircraft.

### BACKGROUND

Modern electric aircraft batteries are prone to overheating and as such require containers with insulation to separate the battery cells from one another. The containers to hold a plurality of battery cells may be bulky and degrade the energy density of battery packs.

### SUMMARY OF THE DISCLOSURE

In an aspect, a system for thermal management of battery cells of an electric aircraft is described herein. The system may include a plurality of battery cells configured to power an electric aircraft, and a barrier coupled to the plurality of battery cells wherein the battery is configured to prevent lithium ejecta from traveling from at least one battery cell of the plurality of battery cells to an adjacent battery cell of the plurality of battery cells.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a front view of an exemplary embodiment of a battery cell;

FIG. 2 is an interior view of an exemplary embodiment of a battery cell;

FIG. 3 is a front view of an exemplary embodiment of a battery pack;

FIG. 4 is front view of an exemplary embodiment of an electric aircraft; and

FIG. 5 is front view of an exemplary embodiment of a barrier positioned next to a battery cell.

### DETAILED DESCRIPTION

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

Described herein is a system for thermal management of battery cells of an electric aircraft. The system may include a plurality of battery cells configured to power an electric aircraft, and a barrier coupled to the plurality of battery cells. In some embodiments, barrier may be configured to prevent ejecta such as lithium ejecta from traveling from at least one battery cell to an adjacent battery cell. In some embodiments, at least a battery cell may include a flexible casing. In some embodiments, the flexible casing may include a plurality of conductive foil tabs. In some embodiments, the plurality of conductive foil tabs may be configured to carry positive and negative terminals to an outside portion of the plurality of battery cells. In some embodiments, at least a battery cell may include at least a lithium-ion pouch cell.

In some embodiments, barrier may include a carbon fiber sheet. In some embodiments, barrier may include two or more carbon fiber sheets. In some embodiments, barrier may include a carbon fiber epoxy. In other embodiments, carbon fiber epoxy may include a gel. In one embodiment, carbon fiber epoxy may be a foam. In some embodiments, the barrier may be configured to be positioned in a corner of the at least one battery cell of the plurality of battery cells. In some embodiments, the barrier may be configured to be positioned at a group of seams of the at least one battery cell of the plurality of battery cells. In some embodiments, the barrier may be configured to reduce a thermal energy of lithium ejecta of a battery cell. In some embodiments, the plurality of battery cells may be configured to be electrically coupled to one another. In some embodiments, the plurality of battery cells may be arranged in a grid pattern. In one embodiment, the electric aircraft may be an electric takeoff and landing vehicle (“eVTOL”). In some embodiments, the battery cells of the plurality of cells may have a sense board. In some embodiments, the barrier may be configured to filter a lithium ejecta from a battery cell of the plurality of battery cells from ambient air. In some embodiments, the barrier may have a polymer mesh having a hexagonal pattern. In other embodiments, the barrier may have a polymer mesh having a grid pattern.

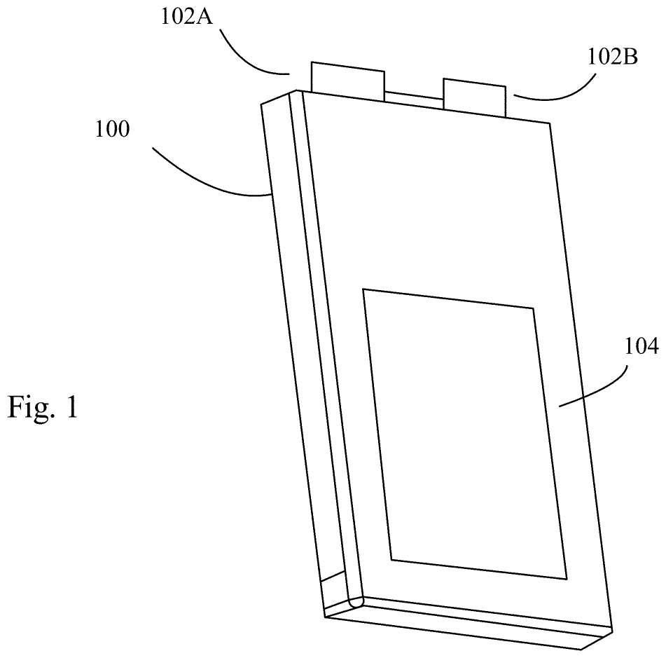

Referring now to FIG. 1, an exemplary embodiment of a battery cell 100 is illustrated. In some embodiments, battery cell 100 may include a pouch cell. As used in this disclosure, “pouch cell” is a battery cell or module that includes a pouch. In some cases, a pouch cell may include or be referred to as a prismatic pouch cell, for example when an overall shape of pouch is prismatic. In some cases, a pouch cell may include a pouch which is substantially flexible. Alternatively or additionally, in some cases, a pouch may be substantially rigid. In some cases, pouch 104 may include a polymer, such as without limitation polyethylene, acrylic, polyester, and the like. In some case, pouch 104 may be coated with one or more coatings. For example, in some cases, pouch 104 may have an outer surface. In some embodiments, outer surface may be coated with a metalizing coating, such as an aluminum or nickel containing coating. In some cases, pouch coating may be configured to electrically ground and/or isolate pouch, increase pouch's impermeability, increase pouch's resistance to high temperatures, increases pouch's thermal resistance (insulation), and or like. An electrolyte may be located in the pouch 104. In some cases, electrolyte may comprise a liquid, a solid, a gel, a paste, and/or a polymer. In some embodiments, electrolyte may include a lithium salt such as LiPF6. In some embodiments, lithium salt may include lithium hexafluorophosphate, lithium tetrafluoroborate, lithium perchlorate, and/or other lithium salts. In some embodiments, lithium salt may be in an organic solvent. In some embodiments, organic solvent may include ethylene carbonate, dimethyl carbonate, diethyl carbonate and/or other organic solvents. In some embodiments, electrolyte may wet and/or contact one or both of at least a pair of foil tabs. Battery cell 100 may include without limitation a battery cell using nickel-based chemistries such as nickel cadmium or nickel metal hydride, a battery cell using lithium-ion battery chemistries such as a nickel cobalt aluminum (NCA), nickel manganese cobalt (NMC), lithium iron phosphate (LiFePO4), lithium cobalt oxide (LCO), lithium manganese oxide (LMO), a battery cell using lithium polymer technology, and/or metal-air batteries. Battery cell 100 may include lead-based batteries such as without limitation lead acid batteries and lead carbon batteries. Battery cell 100 may include lithium sulfur batteries, magnesium ion batteries, and/or sodium ion batteries. Battery cell 100 may include solid state batteries or supercapacitors or another suitable energy source. In some embodiments, the battery cell 100 may be a pouch cell. In other embodiments, the battery cell 100 may be a prismatic, cylindrical, or other type of battery cell. In some embodiments, the battery cell 100 may be a lithium-ion battery. In some embodiments, the lithium-ion battery may include lithium-ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO). Persons skilled in the art, upon reviewing the entirety of this disclosure, will be aware of various devices of components that may be used as a battery cell.

In another embodiment, and still referring to FIG. 1, at least a battery cell 100 may store electrical energy in the form of voltage. In some embodiments, battery cell 100 may include a cathode. In some embodiments, cathode may include a copper current collector. In other embodiments, cathode may include and/or be composed entirely or in part of a graphite active material. In yet another embodiment, cathode may include and/or be composed entirely or in part of a binder such as carboxymethyl cellulose and styrene butadiene rubber. In still another embodiment, cathode may include and/or be composed entirely or in part of a conductive carbon. In some embodiments, cathode may be configured to collect electrons in the form of current. In some embodiments, electrodes may include an anode. Anode may include and/or be composed entirely or in part of an aluminum foil current collector. In another embodiment, anode may include and/or be composed entirely or in part of a metal oxide active material. In other embodiments, anode may include and/or be composed entirely or in part of a binder such as polyvinylidene fluoride. In one embodiment, anode may be a conductive carbon. In some embodiments, anode of battery cell 100 may be configured to deliver electrons to an external load in the form of current. In some embodiments, battery cell 100 may have a cathode tab 102 and an anode tab 104. In some embodiments, cathode tab 102 may be made from aluminum. In some embodiments, anode tab 104 may be made from nickel.

Still referring to FIG. 1, at least a battery cell may have an energy density. Energy density, as used herein, is defined as the amount of energy stored in a given system or region of space per unit volume and colloquially, energy per unit mass (also known as “specific energy”), the units of which may be presented in Joules per kilogram (J/kg), kilocalories per gram (kcal/g), British Thermal Units per pound mass (BTU/lb), and in SI base units, meters squared per seconds squared (m²/s²), and for the purposes of this disclosure Watt hours per kilogram (Wh/kg). In some embodiments, and with further reference to FIG. 1, the energy density of the battery cell 100 may be 150 Wh/kg. In some embodiments, the energy density of the battery cell 100 may be greater than or less than 150 Wh/kg. In some embodiments, the battery cell 100 may have a cell dimension of 140 mm by 8.5 mm by 240 mm. In other embodiments, the battery cell 100 may have a cell dimension greater than or less than 140 mm by 8.6 mm by 240 mm. In some embodiments, the battery cell 100 may have a voltage rating of between 1 and 10 volts. In one embodiment, the battery cell 100 may have a voltage rating of 3.2 volts. In other embodiments, the battery cell 100 may have a voltage rating of over 10 volts. In some embodiments, the battery cell 100 may have a capacity of between 1 and 100 Ah. In one embodiment, the battery cell 100 may have a capacity of 25Ah. In some embodiments, the battery cell 100 may have a weight over 50 grams. In one embodiment, the battery cell 100 may have a weight of less than 50 grams. In one embodiment, the battery cell 100 may have a weight of 530 grams. In some embodiments, the battery cell 100 may have a container 106. In some embodiments, the container 106 may be made from a rigid material. In other embodiments, the container 106 may be made from a flexible material. In some embodiments, the container 106 may be made from aluminum. In some embodiments, the container 106 may have a polymer coating. In some embodiments, the container 106 may.

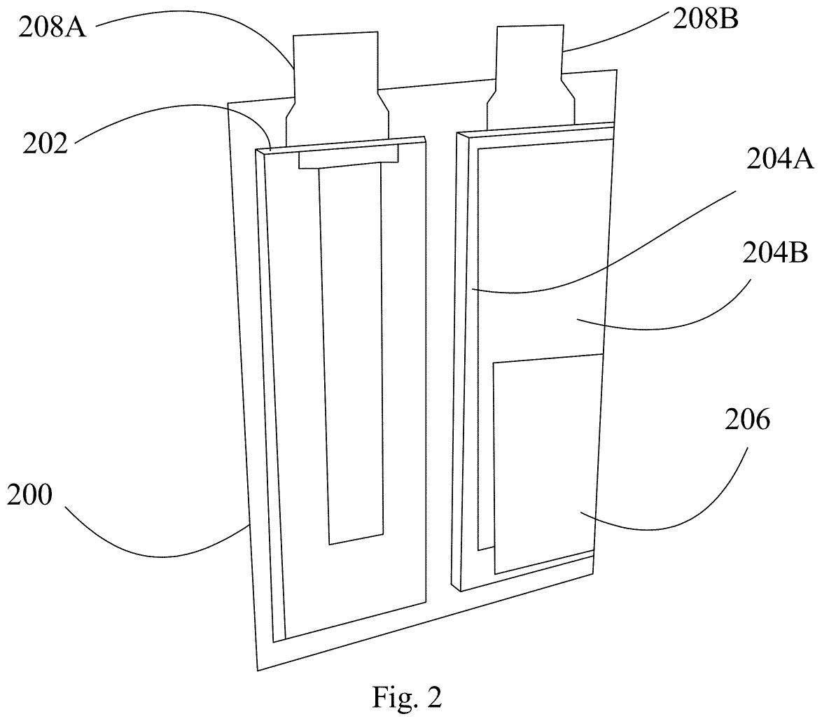

Referring now to FIG. 2, an illustration of an exemplary embodiment of an interior section of a battery cell 200 is shown. In some embodiments, the battery cell 200 may include a lithium-ion pouch cell. Battery cell 200 may include at least a pair of electrodes 204A-B. At least a pair of electrodes 204A-B may include a positive electrode and a negative electrode. Each electrode of at least a pair of electrodes 204A-B may include an electrically conductive element. Non-limiting exemplary electrically conductive elements may include braided wire, solid wire, metallic foil, circuitry, such as printed circuit boards, and the like. At least a pair of electrodes 204A-B may be in electric communication with at least a pair of foil tabs 208A-B. At least a pair of electrodes 204A-B may be bonded in electric communication with at least a pair of foil tabs 208A-B by any known method, including without limitation welding, brazing, soldering, adhering, engineering fits, electrical connectors, and the like. In some cases, at least a pair of foil tabs 208A-B may include a cathode and an anode. In some cases, an exemplary cathode may include a lithium-based substance, such as lithium-metal oxide, bonded to an aluminum foil tab. In some cases, an exemplary anode may include a carbon-based substance, such as graphite, bonded to a copper tab. At least a pair of foil tabs 208A-B may be sealed to the outside section of the battery cell 200. In some embodiments, the conductive foil tabs 208A-B may be configured to connect to an external load or power source.

In some embodiments, and with further reference to FIG. 1, at least a pair of foil tabs 208A-B may be configured to provide power from at least a battery cell to an electric aircraft. In some embodiments, electric aircraft may include an electric vertical takeoff and landing vehicle (“eVTOL”). In some embodiments, battery cell 200 may include a top insulator 202. Top insulator 202 may provide insulation between battery cell 200 and at least a pair of foil tabs 208A-B. In some embodiments, battery cell 200 may include a separator 206. In some embodiments, separator 206 may include an insulation layer. As used in this disclosure, an “insulator layer” is an electrically insulating material that is substantially permeable to battery ions, such as without limitation lithium ions. In some cases, insulator layer may be referred to as a separator layer or simply separator. In some cases, separator 206 may be configured to prevent electrical communication directly between at least a pair of foil tabs 208A-B(e.g., cathode and anode). In some cases, separator 206 may be configured to allow for a flow ions across it. Separator 206 may include and/or be composed wholly or in part of a polymenr, such as polyolifine (PO). Separator 206 may include pours, which may be configured to allow for passage of ions, such as lithium ions. In some cases, pours of a PO separator 206 may have a width no greater than 100 μm, 10 μm, or 0.1 μm. In some cases, a PO separator 206 may have a thickness within a range of 1-100 μm, or 10-50 μm.

With continued reference to FIG. 2, battery cell 200 may include an electrolyte. Electrolyte may be located within battery cell 200. In some cases, electrolyte may include a liquid, a solid, a gel, a paste, and/or a polymer. In some embodiments, electrolyte may include a lithium salt such as LiPF6. In some embodiments, the lithium salt may be lithium hexafluorophosphate, lithium tetrafluoroborate, lithium perchlorate, and/or other lithium salts. In some embodiments, lithium salt may be included, suspended, and/or dissolved in an organic solvent. In some embodiments, organic solvent may include ethylene carbonate, dimethyl carbonate, diethyl carbonate and/or other organic solvents. Electrolyte may wet or contact one or both of at least a pair of foil tabs.

Still referring to FIG. 2, separator 206 may be configured to separate at least a pair of electrodes 204A-B. In one embodiment, separator 206 may separate multiple stacks of cathode and anode layers. In one embodiment, separator 206 may be made from a polypropylene film. In one embodiment, separator 206 may be an aluminum laminate film. In another embodiment, battery cell 200 may be made from aluminum with a polymer coating. In some embodiments, anode 204A may be double sided. In some embodiments, cathode 204B may be double sided. In some embodiments, anode 204A and cathode 204B may be stacked and wrapped in separator 206. In some embodiments, anode 204A, cathode 204B, and separator 206 may be stacked and wrapped in a z-fold pattern. In other embodiments, anode 204A, cathode 204B, and separator 206 may be stacked and wrapped in a rectangular, square, or other pattern. In some embodiments, cathode 204B and anode 204A may be welded together, placing them in a series connection. In one embodiment, cathode 204B and anode 204A may be welded ultrasonically. In some embodiments, cathode 204B and anode 204A may be further welded to at least a pair of foil tabs 208A-B.

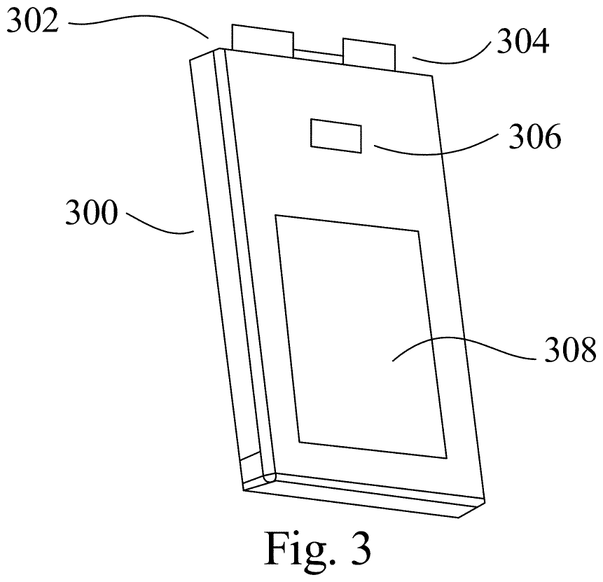

Referring now to FIG. 3, an illustration of an exemplary embodiment of a sense board 306 for a battery cell 300 is shown. In some embodiments, sense board 306 may be integrated into battery cell 300. In some embodiments, a plurality of sense boards may be integrated to a battery cell 300. In some embodiments, sense board 306 may have sensors configured to measure a temperature of at least a battery cell 300. In some embodiments, sense board 306 may have one or more resistance thermometers. Sense board 306 may include, without limitation, a resistance temperature detector, thermocouple, thermistor, thermometer, or other type of temperature sensor. Sense board 306 may include a sensing element that may be made from a metal whose electric resistance increases with increasing temperature. In some embodiments, sense board 306 may include a metal with an electric resistance that quadratically increases with increasing temperature. Sense board 306 may include a negative temperature coefficient (“NTC”) thermistor. NTC thermistor may have a resistance that may decrease with increasing temperature. In some embodiments, NTC thermistor may include a bead, disk, chip, glass-encapsulated, or other NTC thermistor. In some embodiments, sense board 306 may include platinum, nickel, copper, palladium, indium, germanium, or other elements. Sense board 306 may include one or more sensing wires. In some embodiments, sensing wires may be made from a metal. In some embodiments, sense board 306 may have a sensing wire that may be 0.05 mm thick. In other embodiments, sense board 306 may have a sensing wire that may be greater or less than 0.05 mm thick. In some embodiments, the sense board 306 may be secured to a single side of the battery cell 300. In some embodiments, sense board 306 may be secured to two or more sides of the battery cell 300. In some embodiments, the sense board 306 may be configured to relay temperature data to an external computing device. In some embodiments, the sense board 306 may be configured to relay temperature data to an external computing device wirelessly. In other embodiments, sense board 306 may be configured to relay temperature data to an external computing device via a wired connection.

In some embodiments, and still referring to FIG. 3, sense board 306 may include one or more circuits and/or circuit elements, including without limitation a printed circuit board component, aligned with a first side of battery cell 300. Sense board 306 may include, without limitation, a control circuit, which may include any analog or digital control circuit, including without limitation a combinational and/or synchronous logic circuit, a processor, microprocessor, microcontroller, or the like. Sense board 306 may include other sensors configured to measure physical and/or electrical parameters, such as without limitation temperature and/or voltage, of one or more battery cells. Sense board 306 and/or a control circuit incorporated therein and/or communicatively connected thereto, may further be configured to detect failure within each battery cell 300, for instance and without limitation as a function of and/or using detected physical and/or electrical parameters. Cell failure may be characterized by a spike in temperature. Sense board 306 may be configured to detect the spike in temperature and generate signals, which are discussed further below, to notify users, support personnel, safety personnel, maintainers, operators, emergency personnel, aircraft computers, or a combination thereof. Sense board 306 may include passive infrared sensors, resistance temperature sensors (RTD's), semiconductor based integrated circuits (IC), a combination thereof or another undisclosed sensor type, alone or in combination. Temperature, for the purposes of this disclosure, and as would be appreciated by someone of ordinary skill in the art, is a measure of the heat energy of a system. Heat energy is, at its core, a measure of kinetic energy of matter present within a system. Temperature, as measured by any number or combinations of sensors present on sense board 306, may be measured in Fahrenheit (° F.), Celsius (° C.), Kelvin (° K), or another scale alone or in combination. Temperature measured by sensors may comprise electrical signals which are transmitted to their appropriate destination wireless or through a wired connection.

Alternatively or additionally, and with continued reference to FIG. 3, sense board 512 may detect voltage and direct the charging of individual battery cells according to charge level; detection may be performed using any suitable component, set of components, and/or mechanism for direct or indirect measurement and/or detection of voltage levels, including without limitation comparators, analog to digital converters, any form of voltmeter, or the like.

With continued reference to FIG. 3, sense board 306 and/or a control circuit incorporated therein and/or communicatively connected thereto may be configured to adjust charge to one or more battery cells as a function of a charge level and/or a detected parameter. For instance, and without limitation, sense board 306 may be configured to determine that a charge level of a battery cell is high based on a detected voltage level of that battery cell. Sense board 306 may alternatively or additionally detect a charge reduction event, defined for purposes of this disclosure as any temporary or permanent state of a battery cell requiring reduction or cessation of charging; a charge reduction event may include a cell being fully charged and/or a cell undergoing a physical and/or electrical process that makes continued charging at a current voltage and/or current level inadvisable due to a risk that the cell will be damaged, will overheat, or the like. Detection of a charge reduction event may include detection of a temperature, of a cell above a threshold level, detection of a voltage and/or resistance level above or below a threshold, or the like. In some embodiments, sense board 306 may be configured to detect swelling of pouch 308. In some embodiments, pouch 308 may swell when overheated. In some embodiments, sense board 306 may detect both the swelling and temperature of the pouch 308.

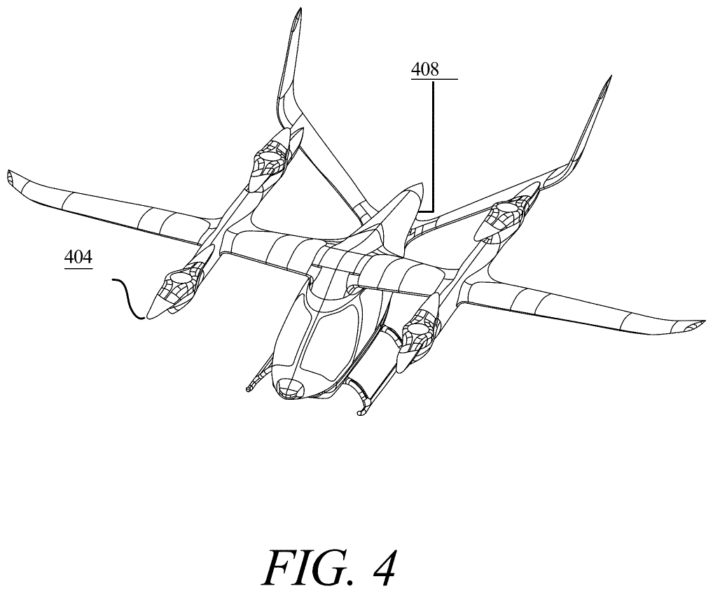

Referring now to FIG. 4, an illustration of an exemplary embodiment of an electric aircraft 400 is shown. The battery cells may power at least a portion of the electric aircraft 400. In some embodiments, the battery cells may be positioned inside the electric aircraft 400. Electric aircraft 400 may include a vertical takeoff and landing aircraft (eVTOL). As used herein, a vertical take-off and landing (eVTOL) aircraft is one that may hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

With continued reference to FIG. 4, a number of aerodynamic forces may act upon the electric aircraft 400 during flight. Forces acting on an electric aircraft 400 during flight may include, without limitation, thrust, the forward force produced by the rotating element of the electric aircraft 400 and acts parallel to the longitudinal axis. Another force acting upon electric aircraft 400 may be, without limitation, drag, which may be defined as a rearward retarding force which is caused by disruption of airflow by any protruding surface of the electric aircraft 400 such as, without limitation, the wing, rotor, and fuselage. Drag may oppose thrust and acts rearward parallel to the relative wind. A further force acting upon electric aircraft 400 may include, without limitation, weight, which may include a combined load of the electric aircraft 400 itself, crew, baggage, and/or fuel. Weight may pull electric aircraft 400 downward due to the force of gravity. An additional force acting on electric aircraft 400 may include, without limitation, lift, which may act to oppose the downward force of weight and may be produced by the dynamic effect of air acting on the airfoil and/or downward thrust from the propulsor of the electric aircraft. Lift generated by the airfoil may depend on speed of airflow, density of air, total area of an airfoil and/or segment thereof, and/or an angle of attack between air and the airfoil. For example, and without limitation, electric aircraft 400 are designed to be as lightweight as possible. Reducing the weight of the aircraft and designing to reduce the number of components is essential to optimize the weight. To save energy, it may be useful to reduce weight of components of an electric aircraft 400, including without limitation propulsors and/or propulsion assemblies. In an embodiment, the motor may eliminate need for many external structural features that otherwise might be needed to join one component to another component. The motor may also increase energy efficiency by enabling a lower physical propulsor profile, reducing drag and/or wind resistance. This may also increase durability by lessening the extent to which drag and/or wind resistance add to forces acting on electric aircraft 400 and/or propulsors.

Referring still to FIG. 4, Aircraft may include at least a vertical propulsor 404 and at least a forward propulsor 408. A forward propulsor is a propulsor that propels the aircraft in a forward direction. Forward in this context is not an indication of the propulsor position on the aircraft; one or more propulsors mounted on the front, on the wings, at the rear, etc. A vertical propulsor is a propulsor that propels the aircraft in an upward direction; one of more vertical propulsors may be mounted on the front, on the wings, at the rear, and/or any suitable location. A propulsor, as used herein, is a component or device used to propel a craft by exerting force on a fluid medium, which may include a gaseous medium such as air or a liquid medium such as water. At least a vertical propulsor 404 is a propulsor that generates a substantially downward thrust, tending to propel an aircraft in a vertical direction providing thrust for maneuvers such as without limitation, vertical take-off, vertical landing, hovering, and/or rotor-based flight such as “quadcopter” or similar styles of flight.

With continued reference to FIG. 4, at least a forward propulsor 408 as used in this disclosure is a propulsor positioned for propelling an aircraft in a “forward” direction; at least a forward propulsor may include one or more propulsors mounted on the front, on the wings, at the rear, or a combination of any such positions. At least a forward propulsor may propel an aircraft forward for fixed-wing and/or “airplane”-style flight, takeoff, and/or landing, and/or may propel the aircraft forward or backward on the ground. At least a vertical propulsor 404 and at least a forward propulsor 408 includes a thrust element. At least a thrust element may include any device or component that converts the mechanical energy of a motor, for instance in the form of rotational motion of a shaft, into thrust in a fluid medium. At least a thrust element may include, without limitation, a device using moving or rotating foils, including without limitation one or more rotors, an airscrew or propeller, a set of airscrews or propellers such as contrarotating propellers, a moving or flapping wing, or the like. At least a thrust element may include without limitation a marine propeller or screw, an impeller, a turbine, a pump-jet, a paddle or paddle-based device, or the like. As another non-limiting example, at least a thrust element may include an eight-bladed pusher propeller, such as an eight-bladed propeller mounted behind the engine to ensure the drive shaft is in compression. Propulsors may include at least a motor mechanically coupled to the at least a first propulsor as a source of thrust. A motor may include without limitation, any electric motor, where an electric motor is a device that converts electrical energy into mechanical energy, for instance by causing a shaft to rotate. At least a motor may be driven by direct current (DC) electric power; for instance, at least a first motor may include a brushed DC at least a first motor, or the like. At least a first motor may be driven by electric power having varying or reversing voltage levels, such as alternating current (AC) power as produced by an alternating current generator and/or inverter, or otherwise varying power, such as produced by a switching power source. At least a first motor may include, without limitation, brushless DC electric motors, permanent magnet synchronous at least a first motor, switched reluctance motors, or induction motors. In addition to inverter and/or a switching power source, a circuit driving at least a first motor may include electronic speed controllers or other components for regulating motor speed, rotation direction, and/or dynamic braking. Persons skilled in the art, upon reviewing the entirety of this disclosure, will be aware of various devices that may be used as at least a thrust element.

With continued reference to FIG. 4, during flight, a number of forces may act upon the electric aircraft. Forces acting on an aircraft 400 during flight may include thrust, the forward force produced by the rotating element of the aircraft 400 and acts parallel to the longitudinal axis. Drag may be defined as a rearward retarding force which is caused by disruption of airflow by any protruding surface of the aircraft 400 such as, without limitation, the wing, rotor, and fuselage. Drag may oppose thrust and acts rearward parallel to the relative wind. Another force acting on aircraft 400 may include weight, which may include a combined load of the aircraft 400 itself, crew, baggage and fuel. Weight may pull aircraft 400 downward due to the force of gravity. An additional force acting on aircraft 400 may include lift, which may act to oppose the downward force of weight and may be produced by the dynamic effect of air acting on the airfoil and/or downward thrust from at least a propulsor. Lift generated by the airfoil may depends on speed of airflow, density of air, total area of an airfoil and/or segment thereof, and/or an angle of attack between air and the airfoil.

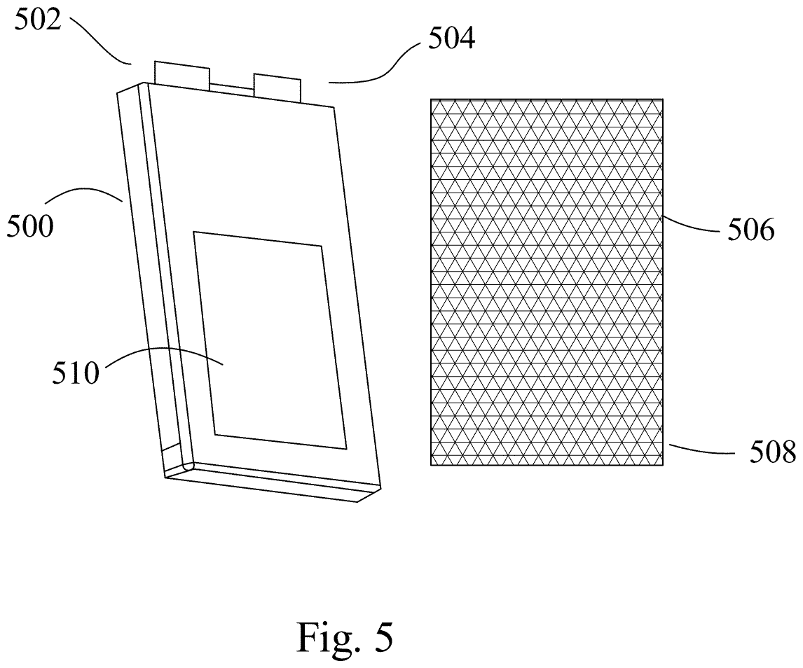

Referring now to FIG. 5, an illustration of an exemplary embodiment of a battery cell adjacent to a barrier is shown. In some embodiments, battery cell 500 may include a lithium-ion battery cell. In some embodiments, the battery cell 500 may be a pouch cell. In some embodiments, battery cell 500 may include a cathode tab 502 and an anode tab 504. In some embodiments, cathode tab 502 and anode tab 504 may be sealed to an outside portion of the battery cell 500. In some embodiments, barrier 506 may be in the form of a sheet. In some embodiments, barrier 506 may be in the form of a flexible sheet. In other embodiments, barrier 506 may be in the form of a rigid sheet. In some embodiments, barrier 506 may be made from a polymer 508. In some embodiments, barrier 506 may be made from carbon fiber. In some embodiments, barrier 506 may be a carbon fiber sheet. In some embodiments, barrier 506 may be constructed from carbon filaments formed from a polymer 508. Polymer 508 may include without limitation polyacrylonitrile, rayon, petroleum pitch, and/or other polymers. Polymer 508 may be spun into filament yarns. In one embodiment, polymer 508 may be fabricated using chemical and/or mechanical processes to align polymer molecules in a way that enhances the physical properties of the polymer. In one embodiment, polymer 508 may be heated to 200 C or more. In one embodiment, polymer 508 may be heated at 300 C. This may break hydrogen bonds in polymer 508 as well as oxidizing said polymer 508. Polymer 508 may then be placed into a furnace having an inert gas such as argon. Furnace may then be heated to about 2000 C. In some embodiments, furnace may be heated to more or less than 2000 C. Polymer 508 may become graphitized. In one embodiment, polymer 508 may include ladder polymers which may form narrow graphene sheets. Graphene sheets may merge to form a single columnar filament. In some embodiments, graphene sheets may merge to form a plurality of columnar filaments. In some embodiment, polymer 508 may be heated further, which may increase the tensile strength of the polymer 508. In some embodiments, polymer 508 may be heated in a range of 1500 C to 2000 C. In some embodiments, the polymer can be heated above or below a range of 1500 C to 2000 C.

In some embodiments, and still referring to FIG. 5, barrier 506 may have a rectangular, ovular, square, or non-regular shape, or any combination thereof. In some embodiments, barrier 506 may include carbon fibers which may be between 5 to 10 micrometers in diameter. In other embodiments, barrier 506 may have carbon fibers which may be greater than 10 micrometers or smaller than 5 micrometers in diameter. In some embodiments, barrier 506 may have a larger surface area than battery cell 500. In some embodiments, barrier 506 may have a smaller surface area than battery cell 500. In some embodiments, barrier 506 may be folded. In some embodiments, barrier 506 may be folded around a battery cell 500. In some embodiments, barrier 506 may be secured to an outside portion of battery cell 500. In one embodiment, barrier 506 may be positioned at the seams of a battery cell 500. In other embodiments, barrier 506 may be separate from battery cell 500. In some embodiments, barrier 506 may be positioned around a battery cell 500. In some embodiments, barrier 506 may replace conventional insulating barriers in a battery pack. In some embodiments, and with continued reference to FIG. 5, the barrier 506 may be configured to reduce the thermal transfer between two or more battery cells 500. The barrier 506 may be configured to catch lithium ejecta from a battery cell 500. In some embodiments, the barrier 506 may filter lithium ejecta from a battery cell 500 from ambient airflow.

As used in this disclosure, and still referring to FIG. 5, “ejecta” is any material that has been ejected, for example from a battery cell. In some cases, ejecta may be ejected during thermal runaway of a battery cell. Alternatively or additionally, in some cases, ejecta may be ejected without thermal runaway of a battery cell. In some cases, ejecta may include lithium-based compounds. Alternatively or additionally, ejecta may include carbon-based compounds, such as without limitation carbonate esters. Ejecta may include matter in any phase or form, including solid, liquid, gas, vapor, and the like. In some cases, ejecta may undergo a phase change, for example ejecta may be vaporous as it is initially being ejected and then cool and condense into a solid or liquid after ejection.

With continued reference to FIG. 5, in some embodiments, barrier 506 may be in the form of an epoxy. In some embodiments, barrier 506 may be in the form of a foam. In some embodiments, barrier 506 may be made from a polymer foam. In one embodiment, barrier 506 may be made from a carbon fiber foam. In some embodiments, barrier 506 may be in the form of a gel. In some embodiments, barrier 506 may be a carbon fiber gel. In some embodiments, barrier 506 may be positioned in a corner of a battery cell 500. In other embodiments, barrier 506 may be positioned in a corner of a battery pack. In some embodiments, multiple barriers may be positioned in multiple corners of a battery cell 500. In some embodiments, multiple barriers may be positioned in multiple corners of a battery pack. In some embodiments, multiple barriers may be positioned in a battery cell 500 and a battery pack. In some embodiments, the barrier 506 may have a polymer mesh with a pattern. The polymer mesh may include a hexagonal, rectangular, grid, or other pattern. In some embodiments, the barrier 506 may filter lithium ejecta from surrounding air of a battery cell. In some embodiments, the barrier 506 may be lightweight and therefore may improve the energy density of a battery pack. In some embodiments, the barrier 506 may be positioned around pouch 510. In some embodiments, the barrier 506 may be configured to prevent the swelling of pouch 506. In some embodiments, barrier 506 may provide structural support to the pouch 506.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments according to this disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A system for thermal management of battery cells of an electric aircraft, the system comprising:
at least one battery cell positioned inside an electric aircraft, wherein the at least one battery cell comprises:
a plurality of conductive foil tabs in electric communication with a motor of the electric aircraft; and
a sense board, wherein:
the sense board is communicatively connected to a temperature sensor configured to collect temperature data of the at least one battery cell; and
the sense board is communicatively connected to an external computing device, wherein the sense board is configured to relay the temperature data to the external computing device; and
a barrier coupled to the at least one battery cell, wherein the barrier filters lithium ejecta from ambient air traveling from the at least one battery cell to an adjacent battery cell of a battery pack of the electric aircraft.

2. The system of claim 1, wherein the at least one battery cell includes a flexible casing.

3. The system of claim 1, wherein the temperature sensor includes a passive infrared sensor.

4. The system of claim 1, wherein the sense board detects a swelling of the at least a battery cell.

5. The system of claim 1, wherein the at least one battery cell includes at least a lithium-ion pouch cell.

6. The system of claim 1, wherein the barrier comprises a carbon fiber sheet.

7. (canceled)

8. The system of claim 1, wherein the barrier includes a carbon fiber epoxy.

9. The system of claim 8, wherein the carbon fiber epoxy includes a gel.

10. The system of claim 8, wherein the carbon fiber epoxy includes a foam.

11. The system of claim 1, wherein the barrier is configured to be positioned in a corner of the at least one battery cell.

12. The system of claim 1, wherein the barrier is configured to be positioned at a group of seams of the at least one battery cell.

13. The system of claim 1, wherein the barrier is configured to reduce thermal energy of the lithium ejecta.

14. The system of claim 1, wherein the at least one battery cell further comprises an anode, cathode, and separator, wherein the anode, cathode, and separator are wrapped in a z-fold pattern.

15. The system of claim 1, wherein the motor of the electric aircraft is electrically connected to a propulsor of the electric aircraft.

16. The system of claim 1, wherein the electric aircraft is an eVTOL.

17. (canceled)

18. The system of claim 1, wherein the barrier has a surface area greater than a surface area of the at least one battery cell.

19. The system of claim 1, wherein the barrier has a polymer mesh having a hexagonal pattern.

20. The system of claim 1, wherein the barrier has a polymer mesh having a grid pattern.

21. The system of claim 1, wherein the sense board is further configured to detect a failure within the at least one battery cell as a function of the temperature data, wherein detecting the failure comprises generating a notification signal, wherein the notification signal notifies a user of the failure.

22. The system of claim 1, wherein:
the sense board is communicatively connected to a voltage sensor, configured to collect voltage data of the at least one battery cell; and
the sense board is further configured to detect a charge reduction event as a function of the temperature data and the voltage data.
